(19) United States
(12) Patent Application Publication
(10) Pub. No.: US 2017/0018790 A1
(43) Pub. Date: Jan. 19, 2017

(54) STACK PROTECTION METHOD IN CASE OF EMERGENCY SHUT DOWN OR BLACK OUT IN SOLID OXIDE FUEL CELL SYSTEM

(71) Applicant: POSTECH ACADEMY-INDUSTRY FOUNDATION, Pohang-si Gyeongsangbuk-do (KR)

(72) Inventors: Jong Shik Chung, Ulsan (KR); Sungtae Park, Pohang-si (KR)

(73) Assignee: POSTECH ACADEMY-INDUSTRY FOUNDATION, Pohang-si Gyeongsangbuk-do (KR)

(21) Appl. No.: 15/121,028

(22) PCT Filed: Feb. 26, 2015
(86) PCT No.: PCT/KR2015/001862

§ 371 Date: Aug. 23, 2016

(30) Foreign Application Priority Data
Feb. 28, 2014 (KR) 10-2014-0024553

(51) Int. Cl. H01M 8/04228; H01M 8/1231; H01M 8/2465; H01M 8/04291; H01M 8/04119

(52) U.S. Cl. CPC H01M 8/04228; H01M 8/04291; H01M 8/04126; H01M 8/2465; H01M 8/1231; H01M 2008/1293

(57) ABSTRACT

The present invention relates to a stack protection method in case of emergency shut down or black out in a solid oxide fuel cell system and, more particularly, to a system and a method for, if supply of fuel gas and water to an anode channel of a stack is discontinued due to emergency shut down or black out, etc. in a solid oxide fuel cell system, preventing an anode from being contaminated by oxygen in the air and preventing re-oxidation of an anode material from occurring and cracks from forming on the stack due to the contamination. A fuel cell according to the present invention is disposed in a hot box along with a fuel cell stack, and has an auxiliary vaporizer which vaporizes and supplies, to a stack anode, water supplied from a water reservoir tank by a water level difference.

### TECHNICAL FIELD

The present invention relates to a method of protecting a stack when an emergency shutdown or blackout occurs in a solid oxide fuel cell system and, more particularly, to a method of preventing contamination of an anode by oxygen in the air and generation of a crack in the stack by re-oxidation of an anode material caused by the contamination, when supply of fuel gas and water to an anode channel of the stack is discontinued due to emergency shutdown, blackout or the like in a solid oxide fuel cell system.

### BACKGROUND ART

A fuel cell is a device for directly converting chemical energy generated by burning a fuel with oxygen into electricity, and in many oases, hydrogen is used as the fuel.

H₂+O₂→H₂O (Electricity and heat are generated)

The fuel cell is manufactured by stacking unit cells configured of an anode, an electrolyte and a cathode, and if air is supplied to the cathode and a hydrogen-containing gas is supplied to the anode, they react and generate electricity and heat.

Representatively, a Polymer Electrolyte Membrane Fuel Cell (PEMFC) and a Phosphoric Acid Fuel Cell (PAFC) use a platinum catalyst as an electrode and operate at a low temperature of about 80° C. and 180° C., respectively, and a Molten Carbonate Fuel Cell (MCFC) and a Solid Oxide Fuel Cell (SOFC) use a metal and a metal oxide as an electrode and operate at a high temperature of 650° C. and in a range of 700 to 900° C., respectively.

Among these, the Solid Oxide Fuel Cell (hereinafter, referred to as SOFC) operating at a high temperature compared with the other fuel cells may use a fuel containing CO or the like together with hydrogen as a fuel supplied to the anode, and since a metal oxide or nickel of low price is advantageously used as a material of the electrode and the electrolyte, they are spotlighted as a high-efficiency low-pollution next-generation power generation method.

The SOFC uses zirconia (hereinafter, referred to as YSZ), added with yttria having a stable crystal structure, for the electrolyte, uses a metal oxide of a perovskite-series, such as LaSrMnO₃, for the cathode, uses a material mixing a nickel oxide and the zirconia for the anode, and operates after deoxidizing the nickel oxide into nickel by supplying hydrogen to the anode in the early stage of the operation.

Contrarily, the SOFC has a problem in that it has a long start-up time to operate due to the high operation temperature. In addition, it is difficult to change an operating condition or temperature during the operation and further difficult to shut down the operation. Particularly, if supply of the fuel is abnormally stopped during the operation, the oxygen flowing backward from the cathode re-oxidizes the nickel, which is the material of the anode, as the stack is cooled down, and a crack is generated in the stack as the volume of the anode expands during the re-oxidization process.

Accordingly, the SOFC requires continuous operation without interruption, and measures for protecting the stack when the operation is abruptly shut down are needed.

Korean Laid-opened Patent No. 10-2010-0120171 discloses a method of continuously supplying a minimum amount of fuel to the anode until the temperature reaches below the oxidation triggering point temperature (300° C.) of the nickel to protect the anode when the operation is shut down.

Korean Laid-opened Patent No. 10-2012-0004938 discloses a method of separating nitrogen gas, which can prevent oxidation of the nickel, from the air and mixing the nitrogen gas with a reformed gas.

U.S. Pat. No. 7,892,678 presents a method of shutting down the operation while cooling down the stack by cooling down the cathode with air and cooling down the anode by injecting water in the front end of a reformer, vaporizing the water and mixing the vaporized water with a reformed gas to cool down the stack in a speedy way after the operation is shut down.

However, these methods are prepared for previously planned operation shutdown, and there is a problem in that they are difficult to be applied when the operation is unexpectedly shut down, for example, when a pump or a device is abruptly out of order, the water or the fuel is abruptly blocked, or electricity supplied from the outside is interrupted by blackout.

Accordingly, it is ceaselessly required to provide a method of supplying a reducing agent or an inert material, such as a hydrogen-containing gas, nitrogen or steam, needed to protect the anode even when the operation is unexpectedly and abruptly shut down.

### DISCLOSURE OF INVENTION

### Technical Problem

Therefore, the present invention has been made in view of the above problems, and it is an object of the present invention to provide a method of protecting an anode by supplying steam to the anode when operation of an SOFC fuel cell is unexpectedly shut down while the SOFC fuel cell is in operation.

Another object of the present invention is to provide an SOFC system provided with an emergency operation device capable of preventing re-oxidization of the anode when the operation is unexpectedly shut down.

Still another object of the present invention is to provide a device for supplying steam to the anode when operation of the SOFC fuel cell is unexpectedly shut down while operating.

### Technical Solution

To accomplish the above objects, according to one aspect of the present invention, there is provided an SOFC fuel cell system having an auxiliary vaporizer rested in a not box together with a fuel cell stack to vaporize water supplied from a water reservoir tank by the difference of water level and supply the vaporized water to an anode of the stack to supply water to the anode of the stack of the fuel cell when the SOFC fuel cell system is abruptly shut down during the operation.

In the present invention, even when an emergency shutdown occurs, such as shutdown of system operation occurred by failure of a device during the operation, discontinuation of fuel, air or water supplied from the outside, shutdown of operation caused by incapability of power transmission due to blackout of the outside or the like, water supplied from a water reservoir tank by the difference of water level is vaporized as steam by an auxiliary vaporizer maintaining a high temperature owing to the stack of high temperature rested in the hot box together with the auxiliary vaporizer, and the vaporized steam is supplied to the anode of the stack, and, therefore, de-oxidization of the anode is prevented.

In the present invention, water is supplied to the auxiliary vaporizer and generates steam at all times during the normal operation, as well as in an emergency situation, and the steam generated by the auxiliary vaporizer may be mixed with fuel gas generated by a vaporizer and provided to the stack. In an embodiment of the present invention, the fuel gas supplied to the stack of the fuel cell may be mixed with the steam generated by the auxiliary vaporizer while passing through the auxiliary vaporizer and supplied to the fuel cell.

In the present invention, since the fuel gas is dissolved in the water supplied to the auxiliary vaporizer, it is preferable to supply the water together with the fuel gas while the water is vaporized. Concentration of the fuel gas dissolve in the water can be adjusted, and the fuel gas is preferably dissolved in a saturated state so that a large amount of fuel can be supplied in an emergency situation.

In the embodiment of the present invention, in order to manufacture water containing dissolved fuel gas, the fuel gas can be dissolved in the water by directly bubbling the fuel gas in the water or spraying the water on the fuel gas inside the water reservoir tank connected to the auxiliary vaporizer. The fuel gas passed through the water reservoir tank is mixed with a fixture of the water generated by the auxiliary vaporizer and the fuel gas while passing through the auxiliary vaporizer again and supplied to the fuel cell stack.

In the present invention, it is preferable to install a flow control valve between the water reservoir tank and the auxiliary vaporizer to continuously supply a small constant amount of water. A valve capable of manually controlling a flow amount can be used as the flow control valve, or an orifice tube for controlling the flow amount in a state of being open at all times can be installed.

In the present invention, the auxiliary vaporizer is placed beside the stack to be close to the stack, and when the stack is cooled down according to an emergency operation shutdown, it is preferable to derive the pattern of temperature with respect to time to be similar to the temperature pattern of the stack.

In the present invention, the SOFC system includes a fuel cell stack operating at a high temperature; a hot box in which the stack is rested and insulated; a preprocessor in which a stack discharge gas exhausted from the stack exchanges heat with air and fuel gas; a water reservoir tank for supplying water to the preprocessor; and a fuel reservoir tank for supplying the fuel gas.

In the present invention, the water reservoir tank is installed at a position higher than the auxiliary vaporizer, and water is supplied to the auxiliary vaporizer by the difference of water pressure (→level) through a pipe connected to the auxiliary vaporizer, and the water is put into the preprocessor through another pipe connected to the preprocessor.

In the present invention, fuel is supplied to the water reservoir tank through a pipe connected to a fuel gas reservoir tank. The supplied fuel gas contacts with water, e.g., bubbled in the water, and then is transferred to the preprocessor through a pipe connected to the preprocessor. In this process, the fuel gas is dissolved in the water contained in the water reservoir tank.

In the present invention, as the stack discharge gas exhausted from the stack flows into the preprocessor through one side and flows out through the other side by way of a stack discharge gas channel and fuel gases respectively containing air and water flow in through the other side and flow out through the one side by way of an air channel and a fuel gas channel, the stack discharge gas and the fuel gases exchange heat with each other. Preferably, a reforming catalyst is installed inside the fuel gas channel.

Water flows into the fuel gas channel of the preprocessor through a pipe connected to the water reservoir tank, and the fuel gas flows in through a pipe connected to the fuel gas reservoir tank and passing through the auxiliary vaporizer. The fuel gas flowing in from the auxiliary vaporizer is mixed with the water supplied from the water reservoir tank and vaporized and flows into the stack together.

In a preferred embodiment of the present invention, the fuel cell system is designed such that an auxiliary humidifier after additionally providing to be separate from a humidifier used for humidifying the fuel gas supplied to the anode of the stack and resting the auxiliary humidifier in the hot box together with the stack to be placed in a temperature environment the same as that of the stack, water is supplied by the difference of height by placing a water supplying reservoir tank at a position higher than the auxiliary humidifier, and a flow restriction device is installed on the pipe so that only an extremely small amount of water can be supplied in normal times. In a facility designed and manufactured like this, a device is manufactured and a process is designed to supply the fuel gas to the water reservoir tank first, dissolve the fuel, gas by bubbling the fuel gas in the water or spaying the water on the gas fuel so that the fuel gas is dissolved in the water at a saturated concentration at all times, and flow the fuel gas into the main humidifier, which is a preprocessing device of the stack, after passing through the auxiliary humidifier first so that the fuel gas may be supplied to the stack by way of a general reformer thereafter.

According to the method proposed in the present invention, a small amount of steam is supplied to the stack at all times even in any emergency situation, such as inoperability of a device, discontinuation of fuel supply, a blackout which is further serious than the others or the like, and in addition, since the fuel gas can be dissolved in the water as much as a saturated solubility and mixed with the steam, if the atmosphere of the gas in the anode is changed to a reducing atmosphere by controlling the oxygen dissolved in the water like the fuel gas, the anode is protected at all times until the temperature inside the anode channel is lowered below the oxidation triggering point of nickel, and thus any inconvenience will not be experienced when the operation is resumed next time.

In addition, the auxiliary humidifier proposed in the present invention provides a method in which since at least an element for vaporizing water is rested beside the in the hot box and stays in an environment of temperature the same as that of the stack, vaporization of the water is maintained since the temperature inside the auxiliary vaporizer is maintained high until the temperature of the stack is lowered below the oxidation triggering point of nickel (about 300° C.), and, in addition, since the water is supplied to the auxiliary vaporizer by the difference of water level between the water reservoir tank and the auxiliary vaporizer, the difference of water level gradually decreases as time goes by, and thus the amount of the supplied water also decreases naturally in connection to cooling down of the stack, and the amount of steam also decreases. Accordingly, since the water level of the water reservoir tank becomes equal to the water level of the auxiliary vaporizer if the stack is fully cooled down to the room temperature and a sufficient time is elapsed, it is preferable to determine the injection position of the fuel gas supplied to the auxiliary vaporizer to be higher than the position where the final water levels become equal to each other for the purpose of smooth flow of the fuel gas when the operation is resumed at a later time.

In the above proposal, if only the steam of a large amount is supplied to the anode when the operation is shutdown, re-oxidation of nickel can be progressed by the oxygen contained in the water at the saturated solubility (for example, in the sense of g of oxygen per L of water, 0.057 of oxygen exists at 10° C. and 0.044 at 20° C.). Accordingly, in the present invention, two safety measures are presented to prevent such a case. The one is a method of bubbling the fuel gas in the water by passing the fuel gas through the water reservoir tank or spraying the water on the fuel gas before the fuel gas is supplied to the humidifier, and the fuel gas is also dissolve in the water at a saturated sol-ability. For example, methane, which is a representative fuel gas, has a saturated solubility of 0.03 at 10° C. and 0.023 at 20° C. Empirically, since about three moles or more of hydrogen is generated per one mole of methane after the dissolved methane undergoes an internal reforming reaction at an external reformer or a nickel catalyst of the anode toy a large amount of steam, if an actual amount of hydrogen is compared by the number of moles with respect to oxygen, concentration of the hydrogen is about four times as high as that of the oxygen, and thus a useful means for maintaining an atmosphere of reducing the anode is provided. The second one is a method of controlling the flow amount of the steam injected into the stack, and this may reduce an absolute amount of the nickel re-oxidized, by the small amount of oxygen in the steam for a predetermined period of time by installing a flow restriction device such as an orifice in the pipe between the water reservoir tank and the auxiliary vaporizer and maintaining the amount of the supplied water to be much smaller (generally less than 1%, preferably less than 0.1%) than the amount of water supplied to the main humidifier/reformer and, at the same time, provides a method of assisting a conversion reaction of the fuel gas dissolved to be saturated to hydrogen so that the reaction may be facilitated at a low temperature by extending the time of the steam staying in the reformer or the anode according to decrease of the flow amount.

In addition, the present invention provides a method of determining a relative height or a storage capacity of a water reservoir tank so that water can be continuously supplied from the water reservoir tank to the auxiliary vaporizer by the relative difference of water level until the stack is naturally cooled down below the oxidation triggering point of nickel.

### Advantageous Effects

The method proposed in the present invention to protect the stack when an emergency shutdown occurs operates until the stack is naturally cooled down to the room temperature without a separate control or without installation or handling of additional equipment even in any emergency situation, such as shutdown of system operation occurred by failure of a device, discontinuation of fuel, air or water supplied from the outside, shutdown of operation caused by incapability of power transmission due to blackout of the outer world or the like, and, for this purpose, the present invention provides an innovative and new stack protection method completed in a simple method of installing an auxiliary vaporizer in the hot box of the stack and slightly changing the position and pipes of the water reservoir tank. In addition, the present invention provides a stack protection, method which can resume the operation at any stage regardless of a time elapsed after operation of the stack is shut down.

### BRIEF DESCRIPTION OF THE DRAWINGS

FIG. 1 is a flow diagram showing the configuration of a water auxiliary vaporizer installed in a hot box of a stack to protect an anode of the stack in an emergency situation, a water reservoir tank which can supply water to the vaporizer by the difference of water level, and related pipes and valves according to the proposal of the present invention.

### DESCRIPTION OF SYMBOLS

1. Stack
2. Facility for heat exchange between stack discharge gas, fuel gas and air
3. Stack discharge gas combustor/cooler
4. Fuel gas humidifier/reformer
5. Air heater
6. Auxiliary vaporizer of fuel gas
7. Hot box for insulating stack and vaporizing part of auxiliary humidifier
8. Reservoir for supplying water and solving fuel gas in water to be saturated
11. Source of fuel gas
12. Supply fuel gas to auxiliary humidifier
13. Supply fuel gas humidified and exhausted by auxiliary humidifier to humidifier/reformer/heater
15. Reformed hydrogen-containing fuel gas supplied to stack
16. Spent fuel gas exhausted from stack
21. Source of air
25. Heated air supplied to stack
26. Spent air exhausted from stack
31. Mixture of spent fuel gas and spent air exhausted from stack
32. Exhaustion of stack discharge gas after combustion/cooling
41. Source of water
42. Water constantly supplied to humidifier/reformer of fuel gas
43. Small amount of water supplied to auxiliary humidifier
51. Pump for supplying constant amount of fuel.
52. Pump for supplying constant amount of air
53. Pump of water reservoir tank for supplying water
54. Pump for supplying constant amount of water from water reservoir tank to humidifier/reformer
61. Valve for blocking supply of fuel gas in emergency
62. Valve for blocking supply of water to water reservoir tank
63. Valve for blocking supply of water to humidifier of fuel gas/reformer in emergency
64. Flow restriction device for supplying small amount of water to auxiliary humidifier
65. Device for controlling water level of water reservoir tank
71. Tube for bubbling fuel gas in water

### BEST MODE FOR CARRYING OUT THE INVENTION

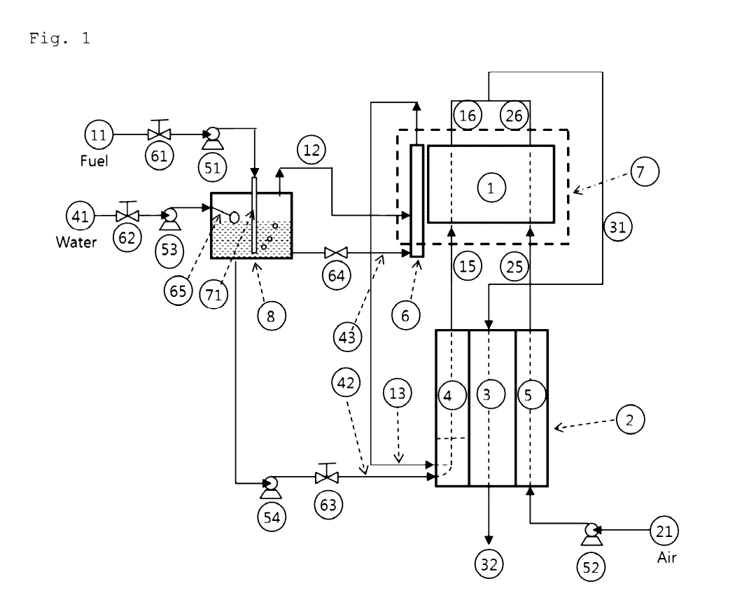

In order to describe the principle of the present invention in detail, a diagram arranging the proposed devices is shown in FIG. 1 together with general facilities of a solid oxide fuel cell. Referring to FIG. 1, the parts different from a general fuel cell system are an auxiliary vaporizer 6 rested in the hot box together with the stack and a fuel gas dissolution facility 71 of the water reservoir tank, and the proposal of the present invention can be accomplished by simply and easily modifying the system not to directly flow the fuel gas 11 and the water 41 into the stack preprocessing device 2 configured of a vaporizer/reformer 4, but to supply the water to the auxiliary vaporizer 6 and flow the fuel gas 11 into the preprocessing device 2 by way of the auxiliary vaporizer 41 (→6). In order to smoothly operate the present invention, first, the water reservoir tank is designed to maintain a constant water level at all times using the water level sensitive valve 71 in normal times, and the water level is gradually lowered over time as the water pump 53 does not operate or the water supply valve 62 is blocked in an emergency situation. At this point, the water is supplied only to the auxiliary; vaporizer 6, and supply of the water to the vaporizer/reformer in the stack preprocessing device 2 is stopped since operation of the pump 54 is shut down or the valve 63 is closed. On the other hand, although the fuel gas 11 flows into the vaporizer/reformer 4 of the stack preprocessing device 2 by way of the auxiliary vaporizer 6 after being saturated in the water while bubbling in the water reservoir tank 8 in normal times, flow of the fuel gas into the stack 1 is blocked by closing the fuel gas valve 61 in an emergency situation. However, since the water is supplied to the auxiliary vaporizer 6 at ail times in any case through the flow restriction device 64, supply of steam to the stack 1 can be continued eventually. If operation of the fuel cell is shut down in an emergency situation, the water level of the water reservoir tank 8 is gradually lowered over time, and the water supplied to the auxiliary vaporizer 6 is also reduced in connection to the decrease of the water level, and supply of water is stopped eventually when the water level of the water reservoir tank 8 becomes equal to the water level of the auxiliary vaporizer 6. Accordingly, a water storage capacity of the water reservoir 8 and a relative difference of water level with respect to the auxiliary vaporizer 6 should be determined in accordance to the flow amount controlled by the flow restriction device 64 so that the temperature of the stack 1 can be lowered below the oxidation triggering point of nickel before supply of water is stopped. The flow amount controlled by the flow restriction device 64 is maintained to be 10% or less, preferably 1% or less, compared with the total flow amount, and since the time of the fuel gas, which is contained in the steam at the saturated solubility of the water, staying in the reformer or the anode of the stack is extended (500 h⁻¹ or less, preferably 50 h⁻¹ or less), a reaction to a gas containing hydrogen is progressed well even at a further lower temperature, and thus oxidation of the small amount of oxygen contained in the steam is prevented.

In the invention proposed as described above, if the capacity of the water reservoir tank 8 is not sufficiently large, it is possible that only some of the fuel gas 11 is passed to the water reservoir tank 8 for the convenience of operation and remaining fuel gas is directly flowed to the vaporizer/reformer 4 installed in the stack preprocessing device 2, and in addition, it may operate to block supply of water flowing into the auxiliary fuel tank in normal times and supply water only in an emergency situation.

1. A fuel cell having an auxiliary vaporizer rested in a hot box together with a fuel cell stack, supplied with water from a water reservoir tank by a water level different from that of the water reservoir tank, vaporizing the supplied water and supplying the vaporized water to an anode of the stack.

2. The fuel cell according to claim 1, wherein the fuel cell is a Solid Oxide Fuel Cell (SOFC) operating at a high temperature.

3. The fuel cell according to claim 2, wherein the SOFC includes: a fuel cell stack;
a hot box in which the stack and the auxiliary vaporizer are rested and insulated; a preprocessor for exchanging heat between a stack discharge gas exhausted from the stack and a fuel gas containing air and water;
the water reservoir tank for supplying water to the preprocessor; a source of air for supplying the air; and a source of fuel for supplying the fuel gas.

4. The fuel cell according to claim 3, wherein the fuel gas is supplied from the source of fuel to the preprocessor together with the vaporized water by way of the auxiliary vaporizer.

5. The fuel cell according to claim 4, wherein the fuel gas is supplied from the source of fuel and passes through the water reservoir tank and the auxiliary vaporizer.

6. The fuel cell according to claim 1, wherein the fuel gas is dissolved in the water supplied from the water reservoir tank.

7. The fuel cell according to claim 6, wherein the fuel gas is dissolved in the water by bubbling the fuel gas in the water while the fuel gas passes through the water or by spraying the water on the fuel gas.

8. The fuel cell according to claim 1, wherein the vaporizer is installed near the stack and heated by the stack.

9. The fuel cell according to claim 3, wherein a flow control valve is installed between the water reservoir tank and the auxiliary vaporizer to continuously supply a small constant amount of water.

10. The fuel cell according to claim 3, wherein in the preprocessor, as the stack discharge gas exhausted from the stack flows in through one side and flows out through the other side by way of a stack discharge gas channel, and fuel gases respectively containing air and water flow in through the other side and flow out through the one side by way of an air channel and a fuel gas channel, the stack discharge gas and the fuel gases exchange heat with each other.

11. The fuel cell according to claim 10, wherein a reforming catalyst is installed inside the fuel gas channel.

12. A method of operating a fuel cell, the method comprising the steps of:
installing an auxiliary vaporizer in a hot box together with a fuel cell stack to be supplied with water from a water reservoir tank,
supplying water to the auxiliary vaporizer using a water level of the water reservoir tank, and
vaporizing the supplied water and supplying the vaporized water to an anode of the stack.

13. The method according to claim 12, wherein a fuel gas is dissolved in the water reservoir tank and supplied to the auxiliary vaporizer.

14. The method according to claim 12, wherein a flow amount of the water supplied from the water reservoir tank to the auxiliary vaporizer is controlled using a flow control device.

15. The method according to claim 12, wherein the fuel gas is supplied to the stack by way of the auxiliary vaporizer.

16. The method according to claim 12, wherein when an emergency shutdown occurs, water is supplied from the water reservoir tank to the auxiliary vaporizer by a difference of water level, and the supplied water is vaporized by the fuel cell stack of high temperature and supplied to the anode of the fuel cell.

17. An auxiliary evaporator installed at a position lower than a water reservoir tank and supplied with water from the water reservoir tank by a difference of height when an emergency shutdown occurs, wherein the supplied water is heated by heat transferred from a fuel cell stack and supplied to an anode of the fuel cell stack.

18. The auxiliary evaporator according to claim 17, wherein water containing dissolved fuel gas is supplied from the water reservoir tank, and a mixture of steam and the fuel gas is supplied when an emergency shutdown occurs.

19. The auxiliary evaporator according to claim 18, wherein during normal operation, the fuel gas passing through the water reservoir tank flows in, and the steam and the fuel gas are supplied together.
